(19) United States
(12) Patent Application Publication
(10) Pub. No.: US 2020/0017157 A1
(43) Pub. Date: Jan. 16, 2020

(54) PERCUSSIVE BELL TO BE ATTACHED TO A BICYCLE HANDLEBAR

(71) Applicant: DECATHLON, Villeneuve d'Ascq (FR)

(72) Inventors: Colin GALLOIS, Villeneuve d'Ascq (FR); Lancelot DURAND, Villeneuve d'Ascq (FR)

(21) Appl. No.: 16/487,276

(22) PCT Filed: Feb. 20, 2018
(86) PCT No.: PCT/FR2018/050400

§ 371 Date: Aug. 20, 2019

(30) Foreign Application Priority Data
Feb. 22, 2017 (FR) 1751398

(51) Int. Cl. B62J 3/00; G10K 1/26; G10K 1/072

(52) U.S. Cl. CPC B62J 3/00; G10K 1/072; G10K 1/26

(57) ABSTRACT

The invention relates to a percussive bell for attaching to the handlebar of a bicycle, the bell having a bell element and a hammer which are mounted on a base with a clamping collar. The hammer is manually movable over a stroke that stresses an elastic member arranged to cause the subsequent movement of the hammer over a percussion stroke. The collar has a first end rigidly secured to the base and a second free end provided with a fastener. The bell element has a matching second fastener that acts jointly with the collar fastener in order to keep the collar in a clamped state about the handlebar and to attach the bell element to the base via the collar.

### CROSS-REFERENCE TO RELATED APPLICATIONS

This application claims the benefit of International application number PCT/FR2018/050400, filed Feb. 20, 2018 and French patent application number 1751398, filed on Feb. 22, 2017, the entire contents of which are incorporated herein by reference.

### TECHNICAL FIELD

The invention relates to a percussive bell intended to be attached to a support, in particular the handlebar of a bicycle.

Such bells are known and comprise a ringer and a clapper, said clapper being capable of being manually moved over a path of travel for stressing a resilient member arranged such that it actuates the subsequent displacement of the clapper over a path for striking the ringer.

The bells are generally fastened near a handle, in particular against the brake ring, in order to allow the cyclist to actuate them using his/her thumb while limiting the loss of grip on the handle, and thus the loss of symmetrical holding of the handlebar, therefore easing the use thereof when cycling.

In order to allow for assembly on a bicycle handlebar, document U.S. Pat. No. 5,307,756 discloses a bell comprising a base on which are mounted the ringer and the clapper, the base being equipped with a clamping collar for clamping about a portion of the handlebar. In particular, the clamping collar comprises a slot defined between two radial edges forming a clamping jaw and connected together by means of a bolt for adjustably closing the collar about the handlebar.

However, this type of bell is not entirely satisfactory since it requires the use of a tool, in particular a screwdriver, in order for it to be fastened to the handlebar, which can be tedious, in particular when the cyclist is looking to adjust the clamping when using the bicycle outdoors, without such a tool being available to him/her. Moreover, the presence of the offset clamping jaw limits the bulk of the bell and detracts from the aesthetics thereof.

In order to overcome these drawbacks, documents EP-0 008 841 and TW-M 455 674 disclose bells with a clamping collar comprising a first end secured to the base and a second free end provided with teeth that is intended to be positioned inside a housing equipped with complementing teeth, in order to allow the clamping of the collar about the handlebar to be adjusted simply using manual traction on the free end, the clamping being maintained by the engagement of the teeth of the collar with the complementing teeth of the housing.

However, these systems are also not entirely satisfactory, in that the clamping obtained thereby is often insufficient. Moreover, the teeth can become progressively worn as the bell is assembled and disassembled, which can have a negative effect on the long-term reliability of the clamping of the collar, and thus lead to the unwanted sliding of the bell about the handlebar.

### SUMMARY OF THE INVENTION

The purpose of the invention is to perfect the prior art, in particular by proposing a compact bell that can be fastened to a handlebar of a bicycle in a particularly simple and intuitive manner, in particular without requiring the use of a tool, moreover the fastening being reliable, even after a plurality of bell assembly and disassembly operations.

For this purpose, the invention relates to a percussive bell intended to be secured to a support, in particular the handlebar of a bicycle, the bell comprising a ringer and a clapper that are mounted on a base equipped with a clamping collar for clamping the bell about the support, the clapper being capable of being moved manually over a path of travel for stressing a resilient member, which is arranged so as to actuate the subsequent displacement of the clapper over a path for striking the ringer, the collar comprising a first end secured to the base and a second free end that is equipped with a fastening means, the ringer comprising an additional fastening means, the engagement of which with the fastening means of the collar is arranged so as to maintain the collar in the state in which it is clamped about the support and fasten the ringer on the base by means of the collar.

### BRIEF DESCRIPTION OF THE DRAWINGS

Other features and advantages of the invention can be clearly observed in the following description, which is given with reference to the accompanying figures, in which:

FIGS. 1a and 1b show a bell according to the invention, respectively a rear view (FIG. 1a) and a median section (FIG. 1b) thereof, wherein the fastening means of the clamping collar are uncoupled from the additional fastening means of the ringer;

FIGS. 2a and 2b show the bell in FIG. 1 in the partially-disassembled state, respectively a rear view (FIG. 2a) and a median section (FIG. 2b) thereof, wherein the tip of the collar is positioned in the receiving housing thereof;

FIGS. 3a, 3b and 3c show the bell in the previous figures, respectively a rear view (FIG. 3a), a median section (FIG. 3b) and a side view (FIG. 3c) thereof, wherein the fastening means of the clamping collar are secured to the additional fastening means of the ringer;

FIG. 4 shows a front view of the bell in FIG. 3.

With reference to these figures, the invention discloses a percussive bell intended to be secured to a support, in particular the handlebar of a bicycle.

### DETAILED DESCRIPTION

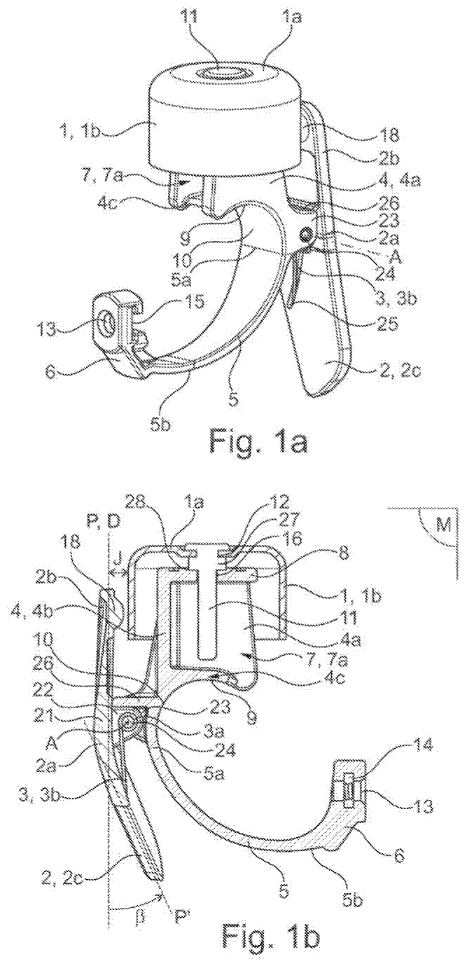

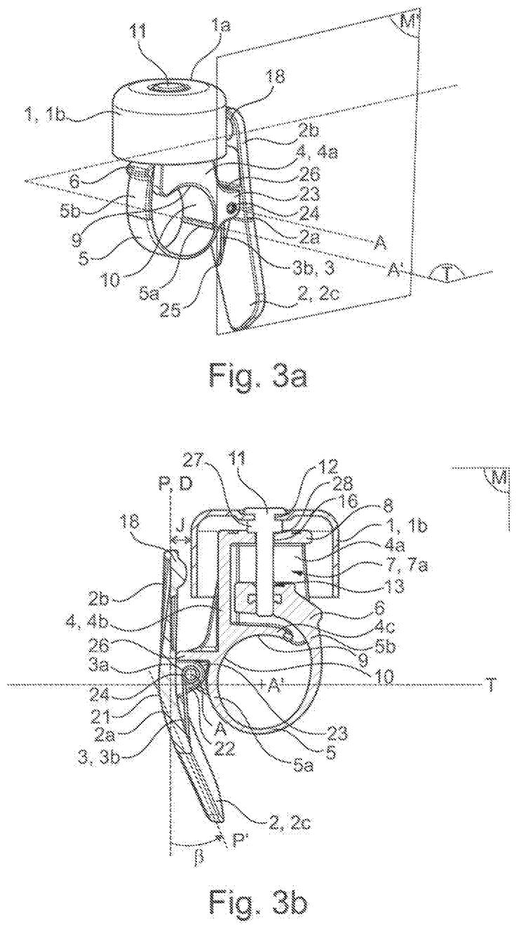

In this description, the terms describing the spatial positioning are taken with reference to the position of the bell relative to the cyclist, when the bell is mounted on a handlebar of a bicycle. Therefore, the terms “front” and “rear” are relative to an arrangement facing the cyclist and opposite the cyclist respectively, the “front” position in particular being shown to the left in FIGS. 1b, 3b, 3c and the “rear” position being shown to the right in the figures. Similarly, the terms “outer” and “inner” are relative to an arrangement that is respectively close to an outer edge of the handlebar, and in particular close to a handle on which a hand is positioned on the bicycle, and close to the centre of the handlebar.

The bell comprises a ringer 1, in addition to a clapper 2 that can be manually moved over a path of travel for stressing a resilient member 3, which is arranged such that it actuates the subsequent displacement of the clapper over a path for striking the bell, both of which being mounted on a base 4 equipped with a clamping collar 5 for clamping the bell about the support thereof.

The collar 5 can be formed in one piece with the base 4, for example by the injection and moulding of a plastic material, in particular polyamide (PA).

The collar 5 comprises a first end 5a secured to the base 4 and a second end 5b that is equipped with a fastening means to allow the collar 5 to be positioned in a state in which it is clamped about the support.

In the embodiment shown, the collar 5 has a flexible strap extending between the two ends thereof, and the free end 5b has a tip 6 that supports the fastening means. In particular, the strap has a U-shaped geometry on which the tip 6 is positioned in order to close the collar 5 about the support.

The base 4 has a housing 7 in which the tip 6 is positioned when the collar 5 is in the state in which it is clamped about the support, the housing being positioned underneath a plate 8 on which the bell is positioned in a fixed state. In particular, the arrangement of the tip 6 in the housing 7 improves the compactness of the bell.

With reference to the figures, the base 4 has three vertical walls 4a, 4b that extend beneath the plate 8, and one horizontal wall 4c that extends between the lower sides of the vertical walls, the four walls 4a-4c defining with the plate the housing 7 for receiving the tip 6. The three vertical walls 4a, 4b comprise two sagittal walls 4a that extend symmetrically on either side of a median plane M, each being arranged in a sagittal plane parallel to the median plane, in addition to a front wall 4b that extends in a frontal plane perpendicular to the median plane.

In particular, the housing 7 opens out into a rear opening 7a formed between the rear sides of the sagittal walls 4a in order to allow the tip 6 to be inserted into the housing 7 through the rear opening.

In order to improve the maintenance of the bell on the handlebar, at least the lower sides of the sagittal walls 4a have a curvature 9 intended to mould to at least one portion of the periphery of the handlebar during the assembly of the bell, which reduces the risks of the unwanted sliding of the bell about the handlebar.

With reference to the figures, the front wall 4b has a lower portion 10 that extends beneath the housing 7 and that has a curvature formed in the continuation of the curvatures 9 of the sagittal walls 4a, the first end 5a of the collar 5 being formed integrally in one piece with the lower portion.

Moreover, the ringer 1 comprises an additional fastening means arranged such that it engages with the fastening means of the collar 5 in order to maintain the collar in the state in which it is clamped about the handlebar and to fasten the ringer on the base 4 by means of the collar. In particular, the fastening means is part of the ringer 1 or is permanently fixed to the ringer 1, so as to be handled by the ringer.

Therefore, the bell is fastened onto the handlebar in a simple manner by means of the ringer 1, which allows the fastening to take place in a particularly simple and intuitive manner, even when using the bicycle outdoors, since it does not require the use of a tool.

With reference to the figures, the ringer 1 is equipped with a threaded rod 11. In particular, the ringer 1 has a cap 1a surrounded by a peripheral skirt 1b, the cap having an orifice 12 inside of which the rod 11 is fastened by extending inside the skirt. Moreover, the rod 11 has a nut 27 intended to be axially tightened underneath the cap 1a after the fastening of the rod inside the orifice 12, in order to lock the fastening.

The ringer 1 can be made of a metal material, in particular with an aluminium base, and the threaded rod 11 can be a standard screw, for example an M4 screw. In particular, the ringer 1 can be formed by stamping and electroplating, then the threaded rod 11 can be fastened to the cap 1a by stamping, in particular using a press.

Furthermore, the tip 6 is equipped with a threaded orifice 13 into which the threaded rod 11 is intended to be screwed when assembling the bell on the handlebar. In the embodiment shown, a nut 14 is positioned inside the threaded orifice, in particular through an opening 15 formed for this purpose on one side surface of the tip 6.

The plate 8 has an orifice 16, in which the rod 11 is positioned when assembling the ringer 1 thereon, so that the rod is screwed inside the threaded orifice 13 positioned in the housing 7. In particular, the positioning of the tip 6 in the housing 7 allows the stresses for screwing the rod 11 into each of the orifices 13, 16 to be aligned. Moreover, the plate 8 has an indentation 28 formed about the orifice 16 and in which the nut 27 is intended to axially abut, after the positioning of the rod 11 in the orifice.

The housing 7 can advantageously have dimensions arranged so as to allow the tip 6 to be maintained with limited relative displacements, which in particular allows the orifices 13, 16 to be vertically aligned, and thus eases the screwing of the threaded rod 11 inside the threaded orifice 13 during assembly of the ringer 1 onto the plate. In particular, the sagittal walls 4a can be spaced apart by a distance that is substantially equal to the width of the tip 6, in order to allow for the maintenance of the tip between the sagittal walls without any clearance.

Therefore, in order to both assemble the bell and mount the bell on the handlebar, the cyclist positions the clamping collar 5 about a portion of the handlebar, then inserts and holds the tip 6 in the housing 7, in particular using one hand. The cyclist then grasps the ringer 1 with the other hand, holding it by the peripheral skirt 1b thereof, in order to mount it on the base 4 by inserting the rod 11 into the orifice 16 of the plate 8 and opposite the threaded orifice 13 of the tip 6. Finally, the cyclist rotates the ringer 1 about the axis of the rod 11 in order to screw it into the threaded orifice 13, so as to maintain the collar 5 in the state in which it is clamped about the handlebar and to fasten the ringer onto the base 4 by means of the collar.

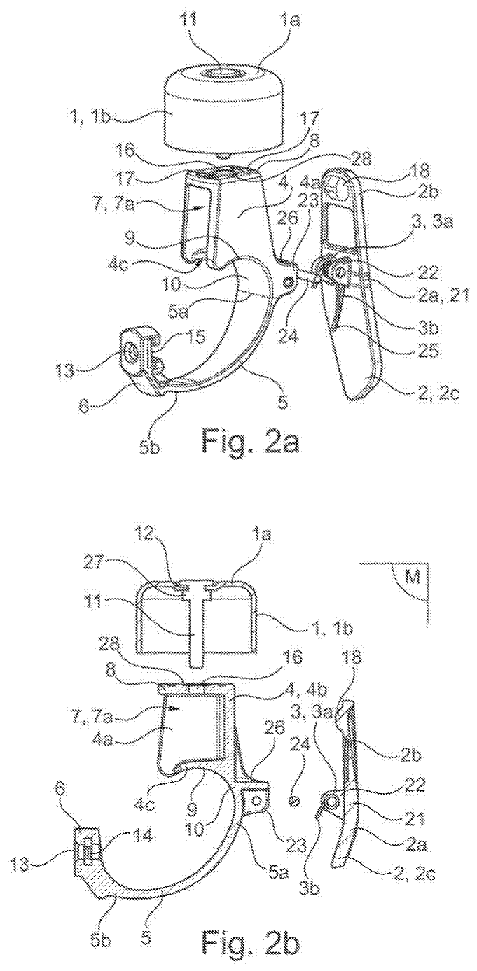

With reference to FIG. 2a, the plate 8 comprises a marking 17, in particular in the form of curved arrows, positioned on either side of the orifice 16, in order to inform the cyclist of the direction in which the ringer 1 must be rotated in order to assemble the bell and fasten it onto the handlebar.

Advantageously, the bell can be fastened near a handle of the bicycle, in particular against the brake ring, in order to allow the cyclist to move the clapper 2 using his/her thumb while limiting the loss of grip on the handle, and thus easing the use of the bell when cycling.

The clapper 2 has a central portion 2a that is mounted such that it rotates on the base 4, the central portion being positioned below an upper lug 2b provided with a percussive area 18.

The clapper 2 also has a lower displacement lug 2c provided with an actuating area 29, the resilient member 3 being positioned between the clapper and the base 4 such that a pressing action on the actuating area 29 distances the percussive area 18 from the ringer 1, while stressing the resilient member 3, the release of the pressing action actuating the striking movement generating the striking of the ringer by the percussive area.

The clapper 2 can in particular be formed in one piece with the lugs 2b, 2c and the central portion 2a, for example by the injection and moulding of a plastic material, in particular having a polyoxymethylene (POM) base.

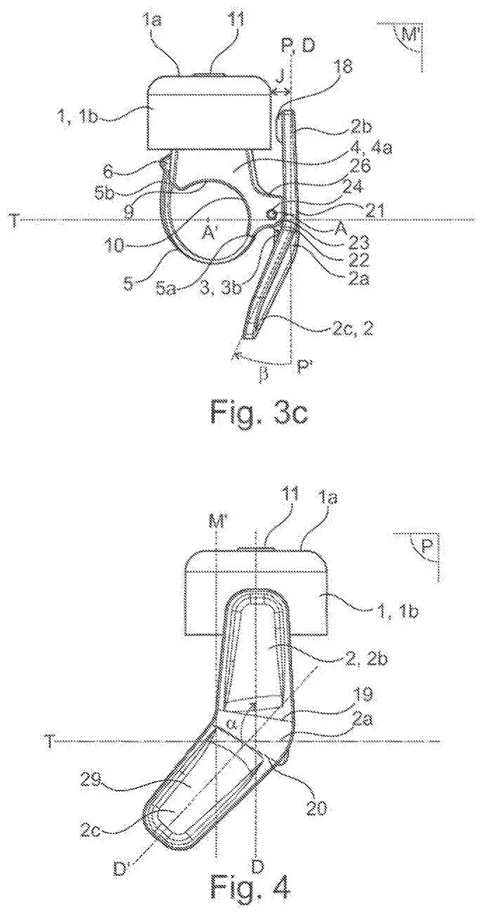

With reference to FIG. 4, the collar 5 is arranged such that it defines an assembly axis A′ of the support, a sagittal assembly plane M′ containing the part of the collar situated the furthest outwards, the part in particular being positioned near the base of a handle of the handlebar, in addition to a transverse plane T perpendicular to the assembly plane M′ and containing the assembly axis A′.

Moreover, the percussive area 18 extends above the transverse plane T, whereas the actuating area 29 extends below the transverse plane, by being offset in the outwards direction relative to the assembly plane M′.

Therefore, advantageously, the actuating area 29 of the clapper 2 is oriented towards a handle of the handlebar, and thus towards a hand of the cyclist, when the bell is mounted on the brake ring of the handle, which allows the actuating area to be brought closer to the thumb, in particular for a small hand of a child, and thus allows the cyclist to press on the actuating area without having to change his/her grip on the handle.

Therefore, the cyclist can use the bell to signal his/her presence while still being able to brake and/or manoeuvre the handlebar using both hands, which guarantees the safety of the cyclist, in particular when this is a child and/or a person learning to ride a bicycle.

In the embodiment shown, the central portion 2a is mounted such that it rotates on the base 4 about an axis A that extends substantially parallel to the assembly axis A′ of the collar 5 about the handlebar, and the upper lug 2b extends in a frontal vertical plane P that is parallel to the rotational and assembly axes.

In particular, the frontal vertical plane P produces a clearance J with the ringer 1, the resilient member 3 being arranged such that the striking path of travel extends over the clearance and such that the upper lug 2b extends in the vertical plane in the absence of any pressing action on the lower lug 2c. Therefore, any unwanted contact between the upper lug 2b and the ringer 1 is prevented, for example in the event of vibrations caused by impacts experienced by the bicycle when in motion, in particular on rough ground.

Furthermore, the dimensions of the clearance J are arranged so as to allow the bell to function correctly. More specifically, if the dimensions of the clearance J are too great, the upper lug 2b will not be able to strike the ringer 1 after the pressing action on lower lug 2c is released, and the bell will not produce any sound. Similarly, if the dimensions of the clearance J are too small, there is a risk of the upper lug 2b striking the ringer 1 multiple times, which will also prevent sound from being generated.

In the figures, the upper lug 2b is equipped with a protuberance 18 on which is formed the percussive area of the ringer 1, the dimensions of the clearance J and the maximum thickness of the protuberance being arranged so as to leave a space between the protuberance and the ringer 1, which space is large enough to prevent any unwanted contact as described above between the protuberance and the ringer.

Moreover, the actuating area 29 of the lower lug 2c can have an indentation for positioning a thumb, so as to provide the cyclist with a visual and/or tactile marker allowing him/her to optimally position his/her thumb in the actuating area, and thus ensure the correct actuation of the bell.

With reference to FIG. 4, the upper lug 2v extends in the vertical plane P in a direction D that is perpendicular to the rotational axis A of the clapper 2. Moreover, the lower lug 2c extends in a direction D′ forming, with the direction D of the upper lug 2b, an angle α measured in the frontal vertical plane P that is strictly less than 180°, and in particular that lies in the range 120° to 160°.

In the embodiment shown, the lower lug 2c also extends in a plane P′ that forms a non-zero angle β in the rear-facing direction with the frontal vertical plane P. Notably, the angle β can in particular lie in the range 10° to 30°.

As shown in particular in FIG. 4, the central portion 2a has an elbow-shaped geometry respectively connecting the lower 19 and upper 20 edges of the upper 2b and lower 2c lugs. Moreover, the central portion 2a has an upper section 21 that is vertically aligned with the upper lug 2b and that is equipped with means 22 for assembling the clapper 2 such that it rotates on the base 4.

In the embodiment shown, the upper section 21 has a hinge element 22 forming means for assembling the clapper 2 such that it rotates on the base 4, and that complements a hinge element 23 of the base 4, a rotation pin 24 being positioned in the assembly of the hinge elements.

Moreover, the resilient member 3 comprises a spring wire having a winding 3a that is immobilised relative to the base 4, in particular by being positioned around the pin 24, and axially inserted between the hinge elements 22, 23, in addition to one end 3b that is at rest against the lower lug 2c so as to move therewith in order to stress the winding.

In particular, the lower lug 2c comprises an indentation 25, the shape of which complements that of the end 3b of the spring 3, and wherein the end is positioned in abutment, in order to prevent any unwanted relative sliding of the end relative to the lower lug.

Advantageously, the lower portion 10 of the front wall 4b has a front lateral extension 26 under which the hinge element 23 is formed, in order to allow the central portion 2a of the clapper 2 to be mounted on the lateral extension such that it rotates under stress from the spring 3.

Therefore, the rotational axis of the clapper 2 is laterally offset, in particular towards the front, relative to the base 4, and therefore relative to the ringer 1, and the lower lug 2c is brought closer to the cyclist's thumb, which further improves the ergonomics of using the bell.

1. A percussive bell configured to be secured to a support, the bell comprising a ringer and a clapper mounted on a base equipped with a clamping collar for clamping the bell about the support, the clapper being capable of being moved manually over a path of travel for stressing a resilient member, which is arranged to actuate the subsequent displacement of the clapper over a path for striking the ringer, the bell wherein the collar comprises a first end secured to the base and a second free end that is equipped with a first fastener, the ringer comprising a second fastener, the engagement of which with the first fastener of the collar is arranged to maintain the collar in the state in which it is clamped about the support and to fasten the ringer on the base by means of the collar.

2. The percussive bell according to claim 1, wherein the collar is formed in one piece with the base.

3. The percussive bell according to claim 1, wherein the collar has a flexible strap extending between the two ends thereof, the free end having a tip that supports the first fastener.

4. The percussive bell according to claim 3, wherein the strap has a U-shaped geometry on which the tip is positioned in order to close the collar about the support.

5. The percussive bell according to claim 3, wherein the base has a housing in which the tip is positioned when the collar is in the state in which it is clamped about the support.

6. The percussive bell according to claim 5, wherein the housing is positioned underneath a plate on which the bell is positioned in a fixed state.

7. The percussive bell according to claim 1, wherein the ringer is equipped with a threaded rod, the free end of the collar being equipped with a threaded orifice.

8. The percussive bell according to claim 6, wherein the plate has an orifice in which the rod is positioned so that the rod is screwed inside the orifice positioned in the housing.

9. The percussive bell according to claim 7, wherein the ringer has a cap surrounded by a peripheral skirt, the cap having an orifice inside of which the rod is fastened by extending inside the skirt.

10. The percussive bell according to claim 1, wherein the clapper has a central portion that is mounted and rotatable on the base, the central portion being positioned below an upper lug provided with a percussive area, the clapper also having a lower displacement lug provided with an actuating area, the resilient member being positioned between the clapper and the base that a pressing action on the actuating area distances the percussive area from the ringer, while stressing the resilient member, the release of the pressing action actuating the percussive movement generating the percussive of the ringer by the percussive area.

11. The percussive bell according to claim 10, wherein the collar is arranged that it defines an assembly axis of the support, a sagittal assembly plane containing the part of the collar situated the furthest outwards, in addition to a transverse plane perpendicular to the assembly plane and containing the assembly axis, the percussive area extending above the transverse plane, the actuating area extending below the transverse plane, by being offset in the outwards direction relative to the assembly plane.

12. The percussive bell according to claim 10, wherein the base has a lateral extension on which the central portion of the clapper is mounted that it rotates under stress from the resilient member.
